(19) United States
(12) Patent Application Publication
(10) Pub. No.: US 2009/0043621 A1
(43) Pub. Date: Feb. 12, 2009

(54) System and Method of Team Performance Management Software

(76) Inventor: David Kershaw, (US)

Correspondence Address: David Kershaw, 70a Todd Pond Road, Lincoln, MA, 01773, US

(21) Appl. No.: 11/836,679

(22) Filed: Aug. 9, 2007

(51) Int. Cl. G06F 17/00

(52) U.S. Cl. 705/7

(57) ABSTRACT

The invention is an application for teams of information workers, their managers, and human resources professionals to evaluate and raise performance based on communication metrics and norms of behavior within a team. A model and management Web pages enable users to collectively set norms of behavior, communicate, make decisions, set roles and goals, receive evaluations according to their norms, and in other ways conduct interpersonal relations in a business context. Modules acquiring data from email and document management systems, groupware, directories, and other information sources are included. Said information is joined with the invention's internally generated data. An expert system generates observations and advice permitting the team to more appropriately deploy information, adhere more closely to its norms, and lessen stress caused by interpersonal friction. Management is provided a means of assessing teams, setting policies, and defining parametric ranges for norms.

### CROSS-REFERENCE TO RELATED APPLICATIONS

U.S. patent application Ser. No. 11/686,712, titled “Recursive Team-oriented Chess-like Game for Entertainment and Training” applied for by the present inventor. The said invention is related to the present invention in that it is an educational game that may be combined with and used in the work environment of the present invention for the purposes of learning the use of the present invention or of more fully developing the learnings offered by the said invention; moreover, the said invention shares some team management characteristics and goals with the present invention.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Team work is prevalent in current practices across the knowledge worker economy and therefore team productivity is as much a concern as individual productivity. The performance of a team is in part determined by the degree of coherence in its member's understandings of roles, goals, values placed on behaviors, and other group norms and context. Building on the team members' initial understandings of team's modus operandi, the communication between team members influences group performance going forward and may highlight potential performance hindering relationships. Individual relationships and one to many relationships within a team may have greater or lesser performance implications depending on the roles of the persons involved, the team's norms with regard to relationships and decision making, and other factors. It is possible that highly productive individuals may work in a dysfunctional or low performing team, and, what is more, it is possible that their high performance behaviors have a negative influence on the team's overall performance. To better observe and manage team performance from an organizational dynamics perspective, a team manager would need the team to operate within a framework that permits the manager to gain insight into the team members' relationships, actions, and values. Likewise, a team member who wished to better understand their own goals, roles, values, or those of others in an explicit framework would need the team to perform within a context that supports context setting, values management, and explicit relationships and expectations management.

While there are established fields of project management software, individual compensation management software, social and business networking software, knowledge management software, and group collaboration software, there is little to no software-embodied method of evaluating and managing the functional health and performance of the team unit itself based on its operational data signature in real-time. What little software does exist in the field of team performance management operates in a subjective, non-real time, and singular first person manner, and has as its goal the delivery of reportage at a point in time to a particular person, typically without expert advice offered regarding the specific circumstances of a particular team. Moreover, the there is no software framework that enables a team to make explicit its internal relationships and its norms of decision making, expectation setting, and communications. Since there is no such framework at the team level, there is also a gap at the higher policies and practices level for departments and companies.

The present invention seeks to provide a measurement based environment for teams to reify practices and values, set goals, form and analyze relationships among team members, negotiate and vote on team practices, collect statistics that indicate information flows and knowledge sharing, make decisions, offer rewards, and receive guidance on their actual functioning against their stated goals and how they can improve performance against those measures. The area of this invention is Organizational Development, and specifically the social interaction of work and the contribution of objectively measurable personal and group interactions to team performance.

This measurement based, operational environment oriented approach stands in contrast to the more typical subjective practices of team coaching, individual mentoring, team building, and team monitoring as performed in a face-to-face setting or mediated through software. The present invention goes beyond the limited ability to assign metrics based on observation and interview that underlies much of the organizational development consulting primarily by being at the center of the team's work processes and therefore directly used by all team members. Moreover, where the academic field of network analysis does quantify inter and intra group connections, the present invention ties these numbers into a team structured, management defined day-to-day business framework for team operations in a way that provides additional real-time metrics, a backdrop for communication pattern analysis, benchmarking against and within specific contexts, and the data model hooks that allow a customizable expert system to provide automated real-time feedback and suggestion.

The present invention is not a project management, groupware, knowledge management, or compensation management solution. What the invention does instead is tap into these common business systems to collect measures of team health and performance in interpersonal interactions. In this respect the invention operates much like an SNMP (Simple Network Management Protocol) monitoring application that measures and analyses physical networks and network applications in a data center. To continue the analogy, the patterns of information interaction within a team may present similarly to the patterns of network traffic within a LAN (Local Area Network) that can lead to bottlenecks, lost packets, and naming collisions if not managed. Similarly, a team that does not communicate well, or that fails to set goals and make decisions in a way that is acceptable in light of company practices and team expectations, will experience blocked decision making, lost information, conflicting efforts, productivity lost to excessive politics, and other common problems.

A relatively small number of individuals and firms have done work that moves in a similar direction to the present invention. The remainder of this Background addresses the known prior art as it applies directly to the present invention.

Circa 2007 The Monitor Group's Lattice Partners unit has created an individual coaching software for use in a team context to offer advice on interpersonal matters and team performance. Their solution, ObservationDeck, requires the user to input data regarding the team experience (much as an interview compiles experience in a more traditional organizational development consulting engagement). Since ObservationDeck has overall similar goals to the present invention a few of the most key differences in approach must be pointed out. The following questions highlight these differences.

How is the performance information collected? In Observation Deck interaction data is entered manually by the observing participant. This makes Observation Deck insights subjective-and in fact Observation Deck is not purely focused on the more ‘mechanical’ or metrics friendly soft skills, as the present invention is, but rather seeks to leverage Monitor company knowledge and insight into areas such as emotional and intentional content in the context of the observer's evaluation of the team's face to face interactions.

Who uses the tool? Observation Deck assumes a leadership or observer position within the team. While the present invention models natural corporate hierarchies and matrix organizations, it does not limit itself to a particular audience. Instead the present invention is a work environment for the whole team and its management to do the key expectations setting, communications, and other interpersonal interactions that help them get their jobs done. What is more, Observation Deck does not appear to offer any portfolio management features that look at multiple teams in one context in a comparative fashion.

How is benchmarking data generated? There is no apparent values-negotiating and values-setting activity in Observation Deck to compare with the present invention, as will be discussed. By not offering this norms management to users of the system and human resources professionals Observation Deck places itself in a passive position vis-à-vis corporate culture setting and appears to keep Observation Deck from contributing to active participation by team members in setting group norms.

Moreover teams do not work in and through Observation Deck to set goals and roles, decide on a decision making model, ask questions, vote and make decisions. Again, this puts Observation Deck away from the actions of the team, lessens the personal involvement of team members with the product, and raises the level of HR commitment required for a successful and lasting implementation of the tool across the organization.

Finally, who is incented to care about the analysis and outcomes of using the tool, and how? The present invention incorporates benchmarking of team and individual performance in a way that offers a mildly competitive arena to promote a set of team chosen behaviors from within a management defined set of practices to be encouraged. ObservationDeck does not take this approach and would not in fact be well adapted to the task of behaviors promotion geared towards the collective and the individual by a dynamic, user-defined and objective scoring model, as discussed below in the Detailed Description of the Invention.

Another firm, Kolbe, has created a team performance prediction and monitoring tool called WAREwithal. From the public documents available, WAREwithal primarily seeks to help managers craft the perfect team by combining skill sets and ambitions against team goals and requirements. This solution also places the burden of entering data on the manager. Moreover, WAREwithal is not used during a team's project work. Rather, WAREwithal is a planning tool whose role ends with the project's start, unless the functional manager responsible for project work seeks answers to why team performance is not meeting expectations. Like ObservationDeck, WAREwithall is based on Organizational Dynamics consulting knowledge and methodologies developed originally for in-person consulting engagements. It is therefore focused on the self-service and automation of subjective input and management reporting. The present invention is geared towards real-time team member focused feedback and communications and decision making correction using a high degree of automation, but not seeking to automate the processes developed for in-person consulting delivery, but rather using a new model of metrics generation. In this the present invention is more detailed and more focused on the “how” rather than the bigger picture “why” behind a situation. A conceptual level, the present invention seeks to reduce the noise in the system by focusing on the mechanics of interactions, and attempts to convince users of the system to work within a framework that makes this focus practical and of high value.

A third performance management tool which may approach some areas of the present invention's methods is TeamThink by Athenium. TeamThink is a question and answer based framework that appears to capture high performance individuals' practices by giving them a means to create questions and answers regarding instances of their best practices. The tool then apparently assesses other team members' performance by presenting questions regarding work situations. Using the data team members enter TeamThink can apparently generate reports of how closely the team or individual team members followed best practices. This description of TeamThink is necessarily thin due to the limited information available to the public. However, clearly TeamThink requires judgment on the part of the system users, is oriented towards job performance, rather than the intrinsic team functioning, must be customized for the operations of a specific company within a particular industry, and collects information in user triggered bursts.

To summarize, the drawbacks of the products mentioned above and the typical current business solutions focused on team performance management are the following.

First, team performance is more subjective than objectively measured. This approach requires a greater investment of effort and a greater chance for error and dispute.

Second, the performance monitoring provides snapshots at observation points. This approach is coarse grained and requires practitioner mediation to enable remediation.

Third, by offering usage primarily to key personnel (a manager or organizational development specialist) the performance guidance is external to the team's work. This approach leads to lower involvement of team members which in turn leads to lower acceptance of course correction efforts.

Fourth, the data collected is entered manually. This approach leads to error and inconsistent collection and expense and therefore less chance for long-term successful adoption across the whole firm, leading away from standard practices.

Fifth, the data collected is not augmented by the team's own perspective and norms setting. This approach adds subjectivity, lowers the number of possible benchmarks, reduces the possible automation of data collection, and reduces team member involvement in the performance monitoring, and therefore team member willingness to adapt behavior to achieve performance goals.

Sixth, the data collected is either based on face to face communications only or is based on communications networks only. This limits the results to specific meetings or to communications traffic (typically at a point in time after the fact), and the resulting limited view of team operations leads to less acceptance of the conclusions.

While not exhaustive, the following listing of patents and additional publicly available software applications as prior art attempts to highlight those inventions that are most obviously representative of their type and that have aspects similar to the present invention. Many, if not most, of these are to some degree complementary to the present invention.

A class of publicly available network applications providing a “social networking” environment, primarily for self expression and communication, but also for lead generation and business networking, typified by group creation, contacts lists, discussion threads, and user generated content, as shown in the MySpace, FaceBook, LinkedIn, UTube, and other Web applications.

A class of publicly available individual performance and enterprise compensation management applications geared towards large scale human resources management and typified by individual work profiles, organizational models, goal setting, periodic evaluations, and enterprise standards setting for performance goals and compensation payoffs, as shown in the SuccessFactors, ExecuTRACK, Inkata, WorkScape, and other enterprise applications.

A class of publicly available groupware enterprise applications typified by email management, directory services, shared documents, group communications, and data and/or document management, as shown in the LotusNotes, Microsoft Office, SharePoint and Exchange trio, and other enterprise application suites.

A class of publicly available project and project portfolio management applications typified by project listings, team composition management, milestone and task tracking, and metrics collection and analysis, as shown in Microsoft Project, Deltek Vision, PlanView, and other enterprise project management applications.

A class of publicly available enterprise knowledge management applications typified by expertise management, group collaboration tools, document management, knowledge asset permissioning, workflow, search and classification, and meta repositories, as shown in Tacit ActiveNet, Oracle Stellent Content Management Server, EMC Documentum, and other similar enterprise information management applications.

U.S. patent application Ser. No. 11/686,712, “Recursive Team-oriented Chess-like Game for Entertainment and Training” (hereinafter the “Game”), by the present inventor for a team training game based on a recursive version of Chess which involves some of the same work group modeling and practices values setting attributes of the present invention. It is anticipated that the Game will provide an artificial work project within the context of the present invention. Used in this manner, the present invention plus the Game will be a high value training for the regular use of the present invention, or leveraging the additional perspectives offered by the Game will be a compelling platform for group learning regardless of the group's intention to continue using the present invention.

U.S. Pat. No. 6,496,812 to Crystal Campaigne and Philip Campaigne, as assigned to Object Power, Inc., hereinafter the “Campaigne Invention”, for an action oriented system and method for organizing team performance according to tasks for which the steps are known incompletely and providing incentives based on performance goals and team roles held by team members. The Campaigne Invention seeks similar outcomes from the present invention; however, the means to the objective are substantially different in intent and practice. Where the present invention sets shared perspective and group communications at the heart of the performance strategy, despite the fact of virtually all of that interaction being ancillary to the execution of tasks against the goal, the Campaigne Invention places the value of actions taken directly in pursuit of the objective at the core of the method. The two approaches are therefore complementary in that they address different challenges to team performance: interpersonal relationships vs. collaborative actions. Both inventions have observing and scoring mechanisms that are critical parts of the feedback loop; however, again the approach is quite different. In the present invention, scoring is performed by collecting simple interpersonal behavior metrics that are amplified using valuations provided by the team members without regard to the actual work or correct functioning of the team; so that it is possible for a dysfunctional team to provide feedback with a negative value, but, at the same time, that feedback would be quantified such that the need for an intervention is clear and that an intervention is practical and efficient. The Campaigne Invention instead seeks to treat performance scoring in much the same way that a genetic algorithm scores outcomes against a goal and thereby narrows the gap with desired performance generation on generation, or in this case, repetition on repetition-and in fact a similar approach is taken in the Campaigne Invention when applied to non-human processes. The observer mechanism is likewise handled in different ways. In the present invention judgment is inconsequential, in and of itself, vis-à-vis the desired work product and is performed by the group itself and secondarily by an expert system informed by expertise of both the discipline of organizational dynamics and the requirements of the specific organization, if needed, as tested against team metrics and in the context of team intent. The Campaigne Invention uses both human observers and non human processes for judging performance. Performance measures are then applied to algorithms to find the fitness of the actions that engendered the measures and that fitness is the core of the feedback. Other aspects of the present invention and the Campaigne Invention continue in this same vein of superficial similarity, but with very different approaches and means to the common end of improved team performance that offer their best value in dissimilar team situations. For instance, the basketball game example used in illustrating the Campaigne Invention would offer no traction to the present invention; whereas, the development and execution of a marketing campaign would be fertile territory for the present invention, but would be significantly less well suited for the Campaigne Invention.

U.S. Pat. No. 6,766,319 to Robert Might for a system and method to collect information from employees in an on-going way using an assigned question and response framework and enable the evaluation of responses.

U.S. Pat. No. 6,064,971 to William Hartnett for a system wherein user contributions to an adaptive knowledge base adjust the contents and structure of future iterations of the same knowledge base.

U.S. Pat. No. 5,722,418 to William Bro for a system intended to reinforce or change individual behavior by the computer mediated intervention of a specialist leveraging a database of possible behavior suggestive questions and statements tailored to the individual.

U.S. Pat. No. 5,890,149 to Robert Schmonsees, as assigned to WisdomWare, Inc., for an interactive knowledge base where the employees of a company collect and navigate through a topic and question based repository of facts and pointers to external systems.

U.S. Pat. No. 6,556,974 to Alex D'Alessandro for a corporate performance prediction system based on a question set provided to employees the results of which can be collected using various means and analyzed to find the performance indicator.

U.S. Pat. No. 4,205,464 to Patrick Baggott for a system to collect information as responses to questions by users and evaluate the coherence of the perspectives of the users.

U.S. Pat. No. 5,241,621 to Ronald Smart, as assigned to Digital Equipment Corporation, for a knowledge processor that uses codified knowledge and thought directive statements to guide a user along a productive thought process.

U.S. Pat. No. 6,876,991 to Daniel Owen and Michael Kusnic, as assigned to Collaborative Decision Platforms, LLC, for a collaborative decision support system that collects information from the users and from external sources and executes logic processes embodied in separate logic programs to generate outputs acceptable to the users.

U.S. Pat. No. 5,717,865 to William Stratmann for a decision support system wherein a user assigns values to the component parts of a decision finding for one of a set of choices in order to evaluate the set of choices.

U.S. Pat. Nos. 5,743,742 and 6,007,340 to Palmer Morrel-Samuels, as assigned to Electronic Data Systems Corporation, for a leadership assessment instrument involving questions directed at a particular objective.

U.S. Pat. No. 4,671,772 to Michael Slade, John Moscicki, and John Greene, as assigned to Keilty, Goldsmith & Boone, for a performance training system that collects performance data and presents motion images indicating performance payoffs to behavior based on an individual's past performance.

U.S. Pat. No. 5,551,880 to Bill Bonnstetter and Jon Hall for an employee success predictive system wherein performance data is collected from successful cases and used to evaluate a prospects question responses.

U.S. Pat. No. 5,684,964 to Michael Powers, Greg Bliss and Shioupyn Shen, as assigned to Teknekron Infoswitch Corporation, for a company performance evaluation system wherein quantifiable aspects of an organization are collected and evaluated.

U.S. Pat. No. 4,682,956 to Leonard Krane for a board game means of ascertaining information on the relationships and personalities of the members of a group.

U.S. Pat. No. 6,615,182 to Michael Powers, et. alii, as assigned to e-talk Corporation, for a means of representing the hierarchy of an organization for use within a performance evaluation system.

U.S. Pat. No. 6,618,723 to Robert Smith, as assigned to Clear Direction, Inc., for a system to advise an individual regarding interpersonal relationship management between that person and another person by evaluating the scores of each on a questionnaire instrument.

U.S. Pat. No. 6,923,653 to Kiju Ito, as assigned to Ricoh Company Ltd. and Ricoh Human Creates Inc., for a system to enhance individual's will to achieve results using a question set to find and filter performance predictors that are then matched to information provided by target individuals.

U.S. Pat. No. 5,655,118 to Lee Heindel, Vincent Kasten and Karl Schlieber, as assigned to Bell Communications Research, Inc., for a system of representing the structured work groups and projects of an organization.

U.S. Pat. No. 5,675,745 to Masayoshi Oku and Shigeki Kusaba, as assigned to Fujitsu Limited, for a means via text analysis of events of creating a model of the structures of the work activities of an organization.

U.S. Pat. No. 5,909,669 to Charnell Havens, as assigned to Electronic Data Systems Corporation, for a system that generates a knowledge worker productivity assessment instrument.

U.S. Pat. No. 5,911,134 to Ronald Castonguay and Gary Crockett for a work scheduling system that models work rules and constraints, and allocates workers according to requirements.

U.S. Pat. No. 5,737,727 to Jean Lehmann, et. alii, as assigned to Electronic Data Systems Corporation, for a work management system that models users and tasks, and the relationships between elements of the model.

U.S. Pat. No. 7,103,609 to Michael Elder, et. alii, as assigned to International Business Machines Corporation, for a system and method for analyzing the usage of information aggregates.

U.S. Pat. No. 6,405,159 to Robert Bushey and Jennifer Mauney, as assigned to SBC Technology Resources, Inc., for a user interface design system whereby users are categorized and scored by their behaviors and thereby grouped for analysis.

U.S. Pat. No. 5,548,506 to Seshan Srinivasan for a message oriented project work tracking system that models projects, tasks, and individuals for the purposes of managing resources and progress.

U.S. Pat. No. 6,507,351 to Donald Bixler for a system and method for the management of personal and group information available from disparate computer mediated sources.

U.S. Pat. No. 5,788,504 to Harold Rice, et. alii, as assigned to Brookhaven Science Associates LLC, for a training development and management system wherein well-known rules and processes form a framework within which training materials can be created and managed.

U.S. Pat. No. 5,826,252 to Richard Wolters, Jr., et. alii, as assigned to General Electric Company, for a system and method for the management of multiple projects of a like type using and constructing best practices by the analysis of data from the spectrum of project performance collected at a central system.

U.S. Pat. No. 6,295,513 to James Thackston, as assigned to Eagle Engineering of America, Inc., for a collaborative inter-company system for developing engineering designs and allocating them to fabricators according to a bids method supported by media relevant to the engineering objective.

U.S. Pat. No. 5,208,765 to Robert Turnbull, as assigned to Advanced Micro Devices, Inc., for a project control system that displays project status as sets of tasks to be completed before a transition to the next set of tasks.

U.S. Pat. No. 5,367,473 to Lynn Chu, et. alii, as assigned to Bell Communications Research, Inc., for a system and method for the application of an expert system to the performance tuning of an operating software application wherein on meeting certain performance thresholds the expert system applies the codified knowledge of expert tuners to the task of generating code that optimizes performance on execution.

U.S. Pat. Nos. 5,761,063 and 6,036,345 to Daniel Jannette, et. alii, the latter as assigned to Lear Corporation, for an engineering and production management system able to oversee and compare the projects and their tasks, progress towards goals, and strategies taken by groups working in an effective competition from the perspective of the system user.

U.S. Pat. No. 4,863,384 to Michael Slade, as assigned to Keilty, Goldsmith & Boone, for an individualized feedback system mediated by a computer and utilizing a questionnaire to elicit data from the individual.

U.S. Pat. No. 5,795,155 to Palmer Morrel-Samuels, as assigned to Electronic Data Systems Corporation, for a system and method for the assessment of leadership in an individual using a question and response format.

U.S. Pat. Nos. 5,208,748 and 5,216,603 to Carlos Flores, et. alii, as assigned to Action Technologies, Inc., for a system and method of conversation structuring and management wherein individuals are assigned conversational roles and their conversations are categorized into “moves” which are oriented to “actions” or “possibilities” and seen within a structure of logical and functional relationships between roles, moves, incompletions and other elements, and wherein external information from calendar and scheduling type applications are integrated so that conversations are seen in the context of calendar events.

U.S. Pat. No. 5,365,425 to Michael Torma, et. alii, as assigned to The United States of America as represented by the Secretary of the Air Force, for a system and method of quality, access and cost management of healthcare facilities wherein analysis of input metrics is used to set goals and performance targets.

U.S. Pat. No. 3,716,928 to R. S. Meyer for a vocational guidance game for groups of players wherein personal decision factors are offered in the form of cards to be placed in meaningful positions on a board to help the players draw conclusions about appropriate vocational choices.

U.S. Pat. No. 6,853,975 to William Dirksen, et. alii, as assigned to Ford Motor Company, for a system and method of rating employees' performance through a highly automated workflow resulting in the collection of ratings from selected coworkers and managers of the rated individual.

U.S. Pat. No. 6,119,097 to David Ibarra, as assigned to Executing the Numbers, Inc., for a system and method of quantifying human performance factors using a set of standards to create a benchmark and target for the individual.

U.S. Pat. No. 6,817,613 to Peter Hasek, as assigned to Electronic Data Systems Corporation, for a board game modeling projects and teaching project management skills to teams of players.

U.S. Pat. Nos. 6,463,441 and 6,735,597 to Mark Paradies, the former as assigned to System Improvements, Inc., for a root cause analysis system that structures the analysis in levels using pre-compiled data to frame and link causes.

U.S. Pat. No. 5,671,360 to Geoffrey Hambrick and Judd Rogers, as assigned to International Business Machines Corporation, for an object model of people oriented processes or projects providing the ability to manage the same.

U.S. Pat. No. 7,216,088 to Oscar Chappel and Christopher Creel, as assigned to Perot Systems Corporation, for a project management system wherein temporally indicated dependencies may be constructed between workers, viewed, and analyzed.

U.S. Pat. No. 5,890,131 to Justin Ebert, et. alii, as assigned to SkyMark Corporation, for a project management system for planning actions and steps, reviewing actions and steps, associating meetings with actions and steps, collecting and assigning the status of actions and steps, and associating software to be executed in association with a step.

U.S. Pat. No. 6,754,677 to Charles Cho, Perlie Voshell, as assigned to OutlookSoft Corporation, for a collaboration system providing non-hierarchical group work on a document resource.

U.S. Pat. No. 6,614,451 to Anne Hudson, John Findlay, and Jonathon Wolfe, as assigned to Grouputer Corporation Pty Ltd, for a computer mediated group work environment where a shared representation of work is available for simultaneous input by group members.

U.S. Pat. No. 6,471,521 to Charles Dornbush, Gary Robinson, Edward Cornelia, as assigned to Athenium, L.L.C., for a collaborative training development and delivery system wherein a training template is presented to collect questions responses, rationales, and discussion points.

U.S. Pat. No. 7,069,266 to Michael Calderaro, et. alii, as assigned to International Business Machines Corporation, for a collaborative system for personnel management wherein is provided a group and individual group member model, and wherein the group member profile includes compensation, performance target and other information, and wherein the functional management of the business is represented along with the groups' members and their management, and wherein permissioning is such that appropriate information is presented to each user of the system while privacy of certain data, for instance compensation data, is reserved for privileged users.

U.S. Pat. No. 6,976,002 to Karen Ferguson, et. alii, as assigned to Steelcase Development Corporation, for a system and method to provide a particular knowledge management solution for an individual according to a profile of that person that is generated according to their observed work patterns.

U.S. Pat. No. 7,082,404 to Michael Calderaro, et. alii, as assigned to International Business Machines Corporation, for a system and method of improved matrix management within a project focused organization, wherein is provided a means for profiling employees according to their project and non-project characteristics, where an example non-project characteristic is compensation and a project characteristic is a project task and its attendant attributes, and wherein is provided a collaborative environment for the discussion and management of the allocation of the managed individual by a set of managers.

U.S. Pat. No. 7,103,562 to Eric Kosiba, Douglas Newhard, and Neofytos Papadopoulos, as assigned to Bay Bridge Decision Technologies, Inc., for a system and method to monitor and tune the performance of a processing center.

U.S. Pat. No. 6,767,213 to Edwin Fleishman, as assigned to Management Research Institute, Inc., for a leadership assessment system with a particular methodology that presents scenarios to a candidate and analyzes the responses.

U.S. Pat. No. 7,110,988 to Andrew Allemann, et. alii, as assigned to Trilogy Development Group, Inc., for a goal alignment system and method wherein goals are structured in hierarchical groups constrained by organizational and other rules for groups and their composition, content and emplacement.

U.S. Pat. No. 5,836,011 to Geoffrey Hambrick and James Rowan, as assigned to International Business Machines Corporation, for an object model representing a human oriented work environment wherein people, projects and processes may be constructed with permissioning and state machine semantics.

U.S. Pat. No. 6,681,197 to Steven Brunner and Craig Smith, as assigned to The Quaker Oats Company, for a performance promotion system wherein an associate makes a quantified estimate against which actuals are compared, the result of said comparison contributing to performance-based compensation adjustments of the associate.

U.S. Pat. No. 6,443,453 to Patricia Wallice for an office performance review game.

U.S. Pat. No. 6,671,695 to Terrence McFadden, as assigned to The Procter & Gamble Company, for a dynamic group model and system wherein ad hoc groups are formed and permuted according to criteria applied to users of the system.

U.S. Pat. No. 6,968,312 to Suzanne Jordan, et. alii, as assigned to International Business Machines Corporation, for a system and method of aligning technical and business practices and objectives by evaluating behaviors, prioritizing objectives and collecting empiric metrics.

U.S. Pat. No. 6,678,671 to Miomir Petrovic and Stephen Van Bruwaene, as assigned to Klocwork Solutions Corporation, for a system and method of linking a resource management system with a projects management system such that tasks and events are tightly bound from the perspective of users of either system.

U.S. Pat. Nos. 6,889,196 and 7,212,986 to Douglas Clark, Sandra Richardson, et. alii, as assigned to Metier, Ltd., for an individual-oriented task management system where the method of reporting status is used to evaluate the predictive capability in said reporting and to adjust predications for other workers and processes.

U.S. Pat. No. 7,181,302 to Jay Bayne, as assigned to Meta Command Systems, Inc., for a multi-level command and control projects and process management system wherein an enterprise's work may be modeled at the lower levels and control processes modeled at the higher levels.

U.S. Pat. No. 5,924,072 to Charnell Havens, as assigned to Electronic Data Systems Corporation, for a knowledge management system and model wherein users are given incentives to add valued knowledge to the knowledge base.

U.S. Pat. No. 6,877,153 to Paul Konnersman for a system and method of interdependent and collaborative project-based decision making support.

U.S. Pat. No. 4,949,278 to Kenneth Davies, et. alii, as assigned to International Business Machines Corporation, for an expert system architecture wherein external programs may access the expert system for knowledge processing.

U.S. Pat. No. 5,771,179 to Leonard White and Caroline White for a multi-level projects management model that associates tasks, applications, projects, objectives and other component parts relating to processes, wherein metrics and attributes of the objects are collected for analysis in a repository.

U.S. Pat. No. 6,983,263 to Lisa Demko, et. alii, as assigned to General Electric Capital Corporation, for an electronic boardroom system wherein documents are managed within process workflows.

U.S. Pat. No. 5,737,494 to Lawrence Guinta and Lori Frantzve, as assigned to Tech-Metrics International, Inc., for a system and method of logical analysis of a process or system whereby the said subject is audited through questions and numeric responses moving from general properties to more specific properties.

U.S. Pat. Nos. 5,960,173 and 6,349,327 to John Tang, et. alii, as assigned to Sun Microsystems, Inc., for a system and method for collaboration and communications based on the task proximity of individuals each engaged in task-based work within applications on networked computers.

U.S. Pat. No. 7,051,036 to Jeffrey Rosnow, Lawrence McManis, Jr., as assigned to Kraft Foods Holdings, Inc., for a project and product management application relying on an internal knowledge base to verify inputs from multiple users.

U.S. Pat. No. 5,812,049 to Moshe Uzi, as assigned to Micro Utility Ltd., for a system and method of monitoring a competitive activity by capturing identity, location, time, duration, and other parameter data for the competitor.

U.S. Pat. Nos. 6,126,448 and 6,213,780 to Chi Fai Ho and Peter Tong for a training management system that provides learning materials according to the job of the user.

U.S. Pat. No. 7,028,221 to Paul Holland, Adam Carr, and Mark McDowell, as assigned to Hewlett-Packard Development Company, L.P., for an expert system based configuration analyzer wherein the analyzer collects information from many network attached enterprise systems.

### BRIEF SUMMARY OF THE INVENTION

This invention is a browser-based Web application apparatus and method of use. The method includes configuration steps and regular use steps. After appropriate configuration the use of the invention facilitates the following activities as pertains to one or more work teams.
1. Expectations setting with regards to the norms of team interpersonal interactions
2. Monitoring performance against set personal, interpersonal, and group goals
3. Monitoring interaction activities
4. Evaluation of team performance
5. Intervention to adjust behaviors and practices
   Furthermore, the invention provides the means to conform policy and project practices for all work teams within a department or company so that best practices can be developed and evolved through practice in a methodical way.

The invention contains a software model of a team organized organization. The model includes the following main entities.
1. Users
2. Groups of users
3. Projects, which may include users and groups
4. Teams, which may include users, groups, and projects
5. Portfolios, which may include users, groups, projects, and teams
   In order to define the interpersonal and group interactions, the model also contains entities that express the following aspects of a team's work.
1. Milestones, skills, goals and citations for work towards goals
2. Decision models, decisions, topics, questions, and votes
3. Relationships between users
4. Roles of users in the context of groups, projects, and teams
5. Rubrics for evaluating aspects of the performance of users, groups, projects, and teams
6. Information events, messages and dictionaries
7. Work rules and the analysis of rules

The preferred embodiment of the invention is a Web application built on a J2EE server; although, other implementation environments are equally viable. The Application is primarily composed of a set of data management Web pages. Each data management page provides the ability to configure the functionality of the Application, or to create, read, update, and delete user and team related data. Data enters the Application from external systems, administrative users, and from end users. External systems provide information regarding users' credentials, project planning, communications, and other aspects of a team-oriented work environment, as configured by administrative users. Administrative users enter data that pertains to how the Application functions for all teams using a set of administrative Web pages. Other end users, as part of their use of the Application, add data that is specific to all teams, one team or a subset of the total number of teams.

After the Application is installed and before it is used by end users it must be configured. The Application has a set of administrative Web pages that are a user interface for configuration. Configuring the application has three main steps that all must happen prior to regular use by a given team.
1. Configure a connection module for each external system the Application will read data from
2. Configure department or organization wide sets of permitted options
3. Add data for each team that will use the Application

The first configuration step is not optional. An administrator of the system must choose the integration modules that will read data from other software systems that support an organization's teams. The following is a non-inclusive list of likely sources of data usable by the application apparatus.
1. Email servers
2. Instant messaging servers
3. Calendar servers
4. Groupware systems
5. Content management repositories
6. Workflow management systems
7. Expertise and knowledge management systems
8. Project management systems
9. Project portfolio management systems
10. Enterprise resource planning (ERP) systems
11. Issue management systems (e.g. help desk software, bug trackers, etc.)
12. Private branch exchange (PBX) servers
13. Video conferencing and collaboration servers
14. Web-based office productivity applications (e.g. Google applications)
15. Human resources management systems
16. Directory servers (e.g. Microsoft Active Directory)

In the second optional configuration step management determines what options the individuals and teams may select in the third configuration step. There are two parts to this configuration step, as follows.
1. Remove options that are unwanted, impractical, or not permitted so as to permit only those options that a department or company deems widely acceptable
2. Modify a subset of the names and labels within the Application to better match the practice within the department or company that will use the Application

The third configuration step consists of managers, team leaders, and individuals setting their profile information, creating teams, creating projects and groups representing their current work, and choosing the configuration of their teams, projects, and groups. The configuration of a team and its projects entails adding information to the application including the following.
1. Individuals' details, including name, description, skills, groups, etc.
2. Project details, including name, dates, description, sponsor, skills, etc.
3. The roles of individuals within the team
4. Selecting a default decision making model
5. Optionally grouping team members within a project and/or within the team
6. Optionally defining milestones within the projects
7. Setting goals for team members and the team within the context of individuals, groups, milestones, projects, and the team
8. Setting individuals' values on behaviors within the team context

Outside of administrative pages, the Application has the following main parts, separated into pages or parts of pages, as configured.
1. A main area for each end user that acts as a navigation hub
2. A management page for teams the logged in user participates in
3. A management page for friends and coworkers of the logged in user, and for his or her other relationships
4. A management page for projects the logged in user participates in
5. A management page for the communications the logged in user took part in
6. A management page for the roles the logged in user has in his or her groups, projects, and teams
7. A management page for the goals of the logged in user and his or her citations
8. A management page for the skills, interests and other profile information of the logged in user
9. A management page for the values and norms of the logged in user
10. A management page for the decision models, decisions, questions and votes of the logged in user
11. A management page for the rubrics and scores against those rubrics of the logged in user
12. A management page for the analysis and advice that the application offers the logged in user

Each of these management pages may also contain information pertaining to other users in the scope of groups, projects, and teams wherein the logged in user and the other users are each members of the given group, project, or team context. Many of these management pages contain historic, personal, and confidential information, as well as information from external systems, that is only viewable by the end user themselves, and in some cases their management hierarchy. In other cases information will be jointly viewable by users who are interacting. The majority of the data, however,

The method of use of the present invention by the individual team members is a permutation of a subset of the following daily activities.
1. Log in and log out
2. Adjust profile information
3. Create and manage projects
4. Check for new messages, and other new information
5. Ask questions of a group or the team
6. Add topics to a user, a group, a milestone, a project or the team
7. Request decisions from the group
8. Vote on the answers to questions, the proposed decisions, and individual users, and comment on the same in the context of a vote
9. Provide a goal for themselves or other team members
10. Give a citation for the work of a team member against a goal
11. Find expertise on a topic from the skills listed by team members
12. Add team members and others to groups within their own, a project's, or the team's context
13. Create relationships between themselves and others in the context of themselves, a group, a project, or the team
14. Send and receive messages within the application and from the application to another type of messaging server (e.g. an email or instant messaging server)
15. Review messaging and other interaction patterns of team members
16. Add references to documents or Web pages to themselves, groups, topics, questions, decisions, milestones, projects and the team
17. Group communications by adding them to a topic
18. Review the dictionary overlap (overlap of words used in communications) of the team members
19. Review team values on team members' behaviors and adjust their own valuations
20. Seek metrics regarding team member behaviors within the context of themselves, another user, a relationship of two users, a group, a project, or the team
21. Seek advice regarding their interaction and communication behavior or the behavior of others within the context of a group, a project, or the team based on the decision model, the values placed on behavior within the context of themselves, another user, a relationship of two users, a group, a project, or the team

The method of use for the management of teams encompasses all of the above activities, and adds further activities particular to managers of teams, human resources professionals, and company executives for the purposes of setting policy, measuring performance against policy, and measuring team performance against other teams. Not all of the following activities are permitted to all management-level users. Those additional activities include the following.
1. Review the team behavior metrics for a set of teams
2. Review usage statistics for a user, team or set of teams
3. Compare average metrics for one or more teams against a set of teams
4. Add or remove options in active use from the sets of options available on each management page described above
5. Compare user metrics where the users are not in a common team or managed by a single manager
6. Review user histories before or after a particular team context exists
7. Review information that is confidential
8. Associate information with a user that is not visible to that user

### BRIEF DESCRIPTION OF THE SEVERAL VIEWS OF THE DRAWING

FIG. 1 is an outline view of the portal style home page layout of the invention showing how information is grouped on the page, including a dashed line delimiting the area below which the user must scroll the view.

FIG. 2 is a more complete depiction of the home page view shown in outline form in FIG. 1. The user has selected a project called “Website redesign” and all other information shown is in the context of this project, with the exception of the Teams Window on the lower left that shows all the projects and groups within the “Web marketing team” that contains the “Website redesign” project.

FIG. 3 is a depiction of a management page for relationships. The page has three sections, of which the view shows the “View” section that gives details on a particular relationship. At the lower right hand side of FIG. 3 there is another three part area that gives further detail on the relationship being inspected.

FIG. 4 is a depiction of a management page for advice showing a categorized observation and a summary of the advice the system is providing for the user in light of that observation.

FIG. 5 is a depiction of one type of interaction visualization provided by the invention. The view shows three users and the strength and direction of their interactions. Strength is assessed according to the number and kind of interactions (e.g. messages, votes, etc.) and direction shows the origin of at least one interaction. Direction is presented using an arrow head end to the edge connecting the vertices that represent the users. Strength is shown via the line thickness of the edge.

FIG. 6 is a depiction of a management page for messaging that is internal to the Application. The context is shown to be the “Website Team” and the “September Re-launch Project”. There are two messages sent by this user and the view shows the contents of one of them. Note the visualization from FIG. 5 is used to show the messages' impact on the overall interactions, as well as for selecting a message to review.

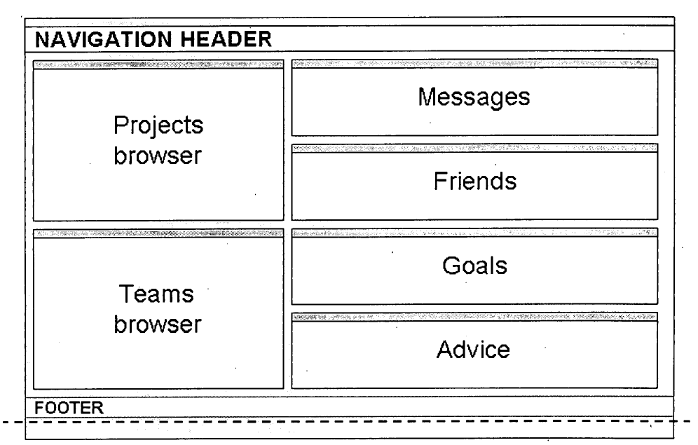

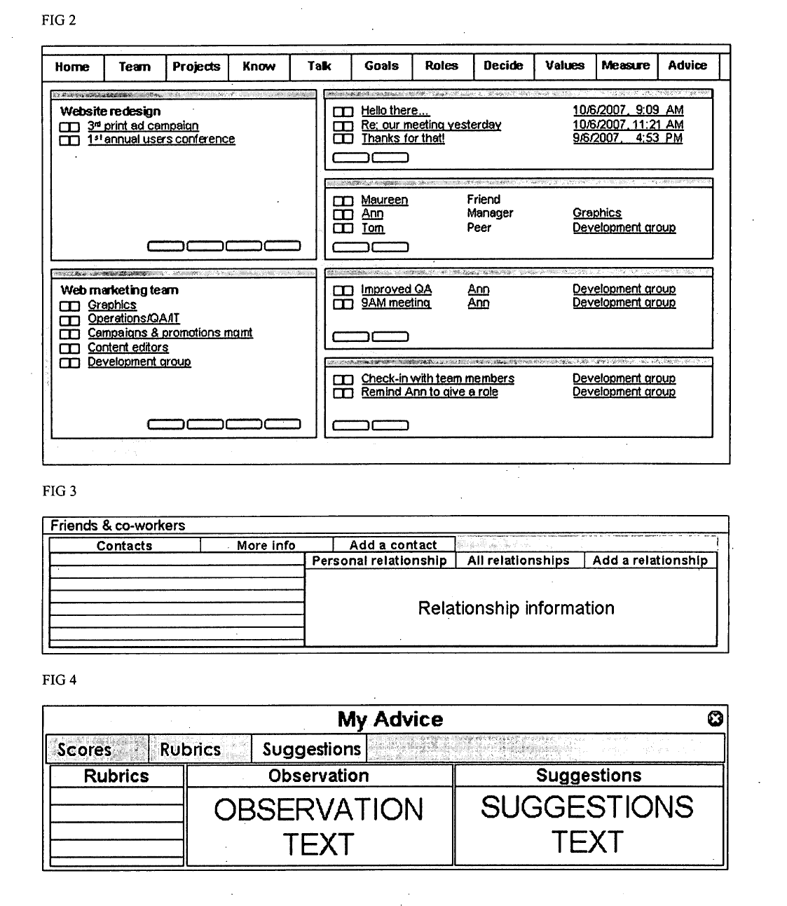

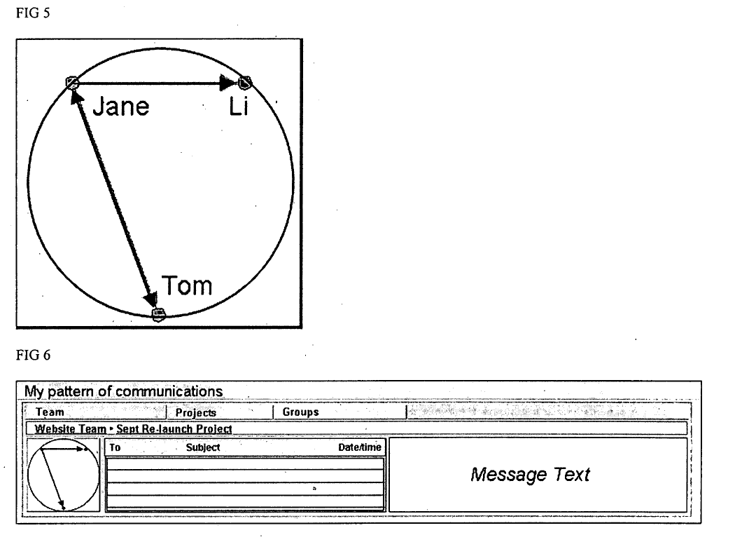

### DETAILED DESCRIPTION OF THE INVENTION

The present invention's preferred embodiment is a Web application (the “Application”) run on a server collocated in a data center or on a network containing other business systems of an organization. Many software platforms and data storage systems may be used to develop the Application and hold its data; however, the preferred embodiment is built on a J2EE application server that, as with any Java-based application, may run on virtually any operating system, and which uses a relational database as its data storage medium, in the case of the preferred embodiment the SQL is standard ANSI and therefore functions correctly in a variety of SQL relational databases. The preferred embodiment maps the objects described below in their Java instance form to the relational entities using JDBC and, in some cases, object relational mapping technology built on top of JDBC. The Web pages described below are, in the preferred embodiment, constructed of HTML, CSS, and JavaScript for delivery to any standards-based Web browser. The preferred embodiment of the Application is collocated in the same data center as the external systems, described below, with which it interacts to read data into its own objects and data store.

The Application's method of use entails configuration and day-to-day work processes. Configuration requires three steps as follows.
1. Installation and technical configuration
2. Configure department or organization wide sets of permitted options
3. Add data for each team that will use the Application

The first configuration step is the technical configuration of the Application. This step includes:
1. Installing the Application as a server either within an existing application server or in a stand-alone form wherein the application server is bundled with the Application
2. Logging in to the Application as the administrative user to continue the technical configuration as follows
   a. Configuring of a set of zero or more connection modules that read data from other business information systems in use within the company of the following types:
      i. email servers
      ii. groupware
      iii. instant messaging servers
      iv. project management servers
      v. project management desktop applications
      vi. issue management servers
      vii. document management servers
      viii. knowledge management servers
      ix. Server-based office productivity applications
      x. Human resources management systems
      xi. Directory servers
      xii. Enterprise resource planning systems
   b. Optionally, the configuration of a default set of rules used by the Application to evaluate the actions of project team members such that the rules are tailored for the specific company's modes of business and objectives for all teams
   c. Creation of an initial business user with the role of “manager” that will continue the business configuration of the Application. The user with the “manager” role may alternatively be the Application administrator user, or the administrator user may give the manager role to a different newly created user.
      Note that by configuring the directory access component the administrator enables users to login using the existing company profiles they have for use on the company's internal network, as is common to enterprise systems.

Once the Application's technical configuration is complete a user must log into the Application in the role of a manager to continue the business configuration of the Application. In this second configuration step the user performs the following:
1. Gives the “manager” role to zero or more user accounts permitting these users to create and sponsor teams
2. Creates one or more teams with zero or more projects (teams and projects are discussed below)
3. Assigns zero or more users to teams, wherein the users exist within the system having been read in from an external source that manages user profiles for the company or from a file source. The Application configuration is not complete until at least two or more users have been assigned to a team.
4. Resets zero or more terms within a list of well-known terms displayed in the user interface of the Application to the particular terms used for the concept indicated within the company
5. Triggers email notifications to the users with the manager role and the users assigned to teams that the Application is configured and ready for them to use.

Users with the manager role are responsible for setting up and managing sets of teams and individual teams of users in the Application. Collections of teams are called portfolios. Managers of teams and portfolios of teams are responsible for all aspects of each team. The only exception to this rule is that users with the “sponsor” role may create a team, or set a team's charter without directly managing the team. Team charters are discussed below. A manager who creates a team and delegates the management of that team is automatically given the role of “sponsor”. Delegation is discussed below.

A portfolio is a set of teams created by a manager or sponsor. The job of a portfolio is simply to collect teams that have a relationship to one another as determined by the creator or manager of those teams. There is no other function of a portfolio. A manager may have multiple portfolios. No portfolio can contain teams that are not managed or sponsored by the user that created the portfolio.

A team is a collection of users that are partnered for a limited time to perform a set task possibly from multiple disciplines within the company. Each team has one or more leaders and one or more sponsors that include the Team creator. Teams have names, descriptions, purposes, and other profile information defining what the team's work is and how the team wishes to be perceived within the company.

A team is created by a user with the “manager” or “sponsor” role. Every team must have a manager. Not every team will have a sponsor separate from its manager. The team manager is responsible for adding users to a team and otherwise configuring the team. A team's sponsor or manager sets a charter for the team laying out the scope of the team's activities. The charter is a statement of intent that may gain associated comments, votes and numeric indicators of priority and status. Note that charters, projects, milestones, and other project management oriented terms are not implemented in the Application with the intent or feature set for the management of projects, but are instead used as indicators or reflections of work that is done in other systems that guides the interactions within the Application. As mentioned above, information from project management systems may be imported to simplify the construction of these indicators.

Teams have users with the “leader” role. Team leaders can create groups of users within the team that have more specific work to do for the team. A team leader may also create projects for the team to work on. Team sponsors and managers may also create projects. There is no limit to the number of projects that can be associated with a team. No project can be assigned to more than one team.

A project is a sub-group of users created within a team. The users that are project members must be members of the team that the project is created within. Project members are partnered within the project to perform specific and finite work that falls within the team's charter. Like teams, projects have leaders and may contain sub-groups of users. Projects may also contain milestones which are indicators of progress towards the project's goals or mark the passage of periods of time. All projects have an end. A project's end may be specified in terms of milestones completed or a date.

As mentioned, teams and projects may contain sub-groups of users. These groups identify users collected for a specific purpose, set of tasks, or to highlight qualifications. Groups are created by managers or leaders of the entity that contains the new group; although, under some decision making models any user may propose a group and the users may vote it into existence. When a group is no longer needed it may be disbanded, generally by its creator or a manager; although, under some decision making models the group may decide to disband of its own accord. Alternatively a group may be given a new purpose and tasks. A group may also contain its own sub-groups. As an example of a group consider a team formed to create a software product. The team leader may create a project to develop a second version of the product. The project leader may create a group of users that work on documentation together. When the documentation is complete, the project leader decides to disband the group.

Individual users have an implicit group that is identical in structure to other groups, but is handled and displayed differently. A user's group is the users' self-selected circle of friends, coworkers, and acquaintances. This group is inherent in the user profile and can not be disbanded; there is no tasks set for this type of group. A user's group has zero or more leaders just as any other group.

In summary there are five fundamental team-oriented organizational structures: user, group, project, team and portfolio. The intent is for these structures to be used to model projects and their teams, not the functional and hierarchical organization of a company. For this reason it is very possible for a team manager to not be the hiring manager of a user-in fact this is likely.

Functional and hierarchical management roles of a company are expressed primarily using roles, attribute fields and references rather than nested structural entities. The expression is as follows.
1. Users have an attribute field for their department name and business unit name
2. Managers and users have relationship entities with the HIRING_MANAGER_OF and HIRED_BY types to express the most fundamental management relationship. This relationship should change when a user is transferred within the company, as well as when they are first hired.
3. Users and managers may have relationship entities with the REPORTS_TO and DIRECT_REPORT types. This is not a mandatory relationship. It is not necessary for this relationship to exist in addition to the HIRING_MANAGER_OF and HIRED_BY relationship.
   These relationships may be browsed in tree form with departments and functional group labels shown, but they do not have fundamental group entities with explicit metadata, as would be more likely true of a directory system or other organizational management system such as a compensation management application.

The Application model is primarily concerned with matrix organizational concepts revolving around the team; however, the functional management roles are necessary both to effectively map the Application structures to the functional perspective of actual companies, and to provide the team creation and management hierarchy that permits teams to come into being, operate within an executive context, and be disbanded when no longer required. Together the functional and matrix axes of the Application are the scaffolding for users to model their work life. Within these contexts users have the opportunity to do the following, as will be further discussed below:
1. Learn about and from their colleagues
2. Create communications between themselves
3. Negotiate and set norms of behavior
4. Provide work and interaction guidelines
5. Give feedback and review behavior
6. Make decisions
7. Evaluate their performance and the performance of others
8. Compare their values and the values of others with regards to behavior against the collectively set norms
9. Get observations and advice from the Application and other users

The initial task for a user is to set up their profile. While some profile information may be brought in from an external system, many of the fields will be unique to the Application. Much of the profile is basic contact and description information; however, the Application goes beyond the basics to describe the user or otherwise advertise or categorize his or her functions, expertise, teams history, relationships, experience, group interaction preferences. Expertise categorization is a function of the following.
1. The user's own skills assessment, if any
2. A manager's skills assessment, if any
3. Information gained by the system over time regarding the activities of the user (e.g. answers to questions associated with a topic or labeled with a meme)
4. Any expertise data that can be brought in from an expertise management system via a connection component.

### Internal and External Explicit Communications

Explicit communications is one of the best ways for the Application to gauge the vitality of interactions and information flows between users within a team. The three types of explicit communications functionality are communications passing, monitoring and management. Metrics generated from these areas are valued by the members of a team using several rubrics and contribute to the overall scoring of the user and team through those rubrics. Rubrics and scoring are discussed below.

Within the Application users can send persistent email-like messages (hereinafter “internal email”) or instant messaging like messages (hereinafter “internal IM”) which are aged out if not received by the addressee within a set period of time. Internal email behaves in every way like regular email, except that it does not permit attachments and can not be sent outside the Application. Internal IM is in every way like regular IM, except the following.
1. Messages may persist for a set duration during which time they will be received if the addressee logs in to the Application
2. Messages may be broadcast to topics, groups, projects and teams.

Users send internal email from a messaging management page. The message management page permits the user to send, view, and delete their internal email. When a message is sent it is logged by the Application for analysis. The content is additionally parsed and stored for search and display as an inverted tree structure called a Message Dictionary, but without maintaining the original content so that any display of terms within the message from this secondary source is necessarily in the abstract and aggregate.

Users send internal IM from a small component that may be displayed at the user's option at various places in the Application. Internal IM is also managed in the message management page. That page permits the user to see their undelivered messages and configure the duration of such messages for various lengths of time.

The Application monitors communications external to itself involving users that log in. As described above, an administrator configures a connection component that links an email server with the Application when the Application is first configured. When a user logs in to the Application, and at certain points during their usage, the Application queries the email server for the To, From, Cc and Bcc fields of messages sent and received by the user since the last check. These addresses are added to the data collected by the Application as Information Events. In addition to the addresses of external explicit messages, the Application can optionally be configured to collect the message content and subject for inclusion in the inverted tree structure used to index internal messages.

An Information Event primarily represents a non-explicit message between users. Explicit messages are addressed to one or more users. Non-explicit messages are ways that a user communicates with other users through actions. Most actions that a user takes are represented in the Application as Information Events. The following examples are all instances of creating non-explicit messages. (Voting, questions, and memes are discussed below).
1. Creating a group
2. Voting
3. Asking a question
4. Attaching a meme

In a like manner the Application can be configured with a connection component that pulls information from an instant messaging server to create Information Events. Instant messaging messages are also considered explicit messages, but like all external information contribute only to the collection of Information Events associated with the user, rather than to the user's internal messages. As with email, instant messages' content may be collected and added to the user's message content inverted tree, at the Application's administrator's option and where the IM server supports that feature.

In a like manner the Application can be configured with a connection component that accesses a SIP (Session Initiation Protocol) server to capture call start and end points for inclusion in the set of Information Events for a user. The SIP server must support SIP extension RFC 3265 or another SIP extension, or an implementation API enabling the information required to be collected out of band from the voice and primary SIP traffic of the call. In the case of a SIP originated Information Event there is no option to capture the content of the message for inclusion in the user's Message Dictionary.

When needed the Application will treat internal email and internal IM messages as Information Events and include them interleaved within the total ordered set of all Information Events. This is most useful when the set of all communications is inspected in a sequential fashion, such as in a timeline.

### Team Norms of Behavior

Teams within the Application have several ways to set and manage norms of interpersonal work-related behavior. The primary and explicit means within the Application are:
1. Setting a default decision making model for the team and any projects or groups
2. Severally setting rubrics that attach point values to behaviors and conditions
3. Setting a team persona that expresses how the team perceives itself

The most primary of these means is that any collection of users may adopt a default decision making model. A decision making model is a signal that the group has selected a particular way of making decisions in the usual case. Each decision to be made or question to be answered may have its own decision model separate from the default; however, the default is a key piece of expectation setting, and also impacts how or whether the Application offers users choices, or which choices it offers, in some situations. The decision making model choices include the following.
1. Unanimous consent
2. Consensus
3. Majority rule
4. Super majority rule
5. Leader decides when the majority can not
6. Leader takes input from the group
7. Leader offers the group choices
8. Leader decides among choices known to the group
9. Leader decides without necessarily making choices known to the group

Because they are easily quantifiable, all of the majority rule style options are used by the Application's expert system (discussed below) in evaluating actual decision making behavior and making observations and recommendations known. The leader oriented options are somewhat less quantifiable; however, here again some options can be tested by the expert system against actual decisions. For instance, if a question or point of decision is posted under “Leader takes input from the group” and it is marked resolved by the leader prior to any other team member commenting or voting on the set of resolution options, the conclusion is clear: the leader did not in fact take input from the group. No doubt it is possible the leader achieved a discussion within the group outside the Application; however, the Application would none the less remonstrate with the leader when he or she checked for observations and advice.

Rubrics are another key means for users to collectively set norms of behavior. A rubric is a guide to the evaluation of a behavior within a team, project, or group. Every user of the Application contributes a set of rubrics to their team. Each rubric sets an explicit numeric value on a particular behavior or circumstance that a group member takes or finds themselves in. Rubric values may be negative. As part of the team setup, team sponsors, managers, and leaders can set ranges for the possible values of any or all rubrics. Even when a team member does not choose to set a rubric value they contribute to the team's valuation for that rubric because a default value exists. The algorithm for finding a team rubric value is to take the average of the value set by each team member; however, other algorithms are equally possible, including weighting rubrics values set by leaders, managers, and sponsors. When rubrics are considered within the context of a project or group, the rubrics of the set of users that are participants of that project or group are used to determine the rubrics of the project or group in a like manner to the derivation of the rubrics of the larger team.

Rubrics are used to generate scores for users. There is no way to “win” the Application because it is not a game; however, the fact of there being scores can and should inspire a mildly competitive environment that will encourage users to pay attention to decisions, guidelines, norms and suggestions for their team, project, group and individual behavior. Each user has several scores:
1. Their own score generated by applying their rubrics to their observed behavior
2. Their team score generated by applying the team rubrics to the users observed behavior
3. A project score for each project the user is a member of generated by applying the project rubrics to the users observed behavior
4. A group score for each group the user is a member of generated by applying the group rubrics to the users observed behavior
5. A user score for each user in the team the user is a member of generated by applying that other user's rubrics to the user's observed behavior
6. A manager score for each manager or sponsor the user is directly or indirectly under generated by applying the manager's or sponsor's rubrics to the user's observed behavior

The scoring system allows a user to evaluate their actions in light of others' explicitly stated preferences. In addition, the user's own rubrics permit the user to broadcast a context within which the user would like others to evaluate their actions. The group rubrics have the effect of setting norms of behavior for sets of users. At the option of the Application's administrator and a team's manager or sponsor, under leader oriented decision making models team, project, and group rubrics may be overridden and set by leaders of teams, projects, and groups.

Rubric generated scores are used by managers and sponsors to compare teams, projects, groups, and users, potentially with consequences outside the Application. Sponsors and managers can not only see reports of their teams, projects, groups, and users they can also see the teams, project, groups and users across the company. This broad reporting is intended to set up a mildly competitive context for work teams. In addition, the information and scores generated by rubrics setting is used by the Application's expert system to evaluate individual behavior within a context and offer observations and advice.

Many rubrics are offered by the Application. The administrator or sponsor or manager at the team's level may enable and disable rubrics for a particular team or team's context, including setting which rubrics will be used across the board. The ability to enable or disable rubrics is an incremental permission to the manager role, and so can itself be disabled for a given manager or sponsor. Rubrics are defined in terms of a query on the Application's model accessed by means of a standard interface. With this structure new rubrics may be defined and distributed as incremental components to the Application that the administrator can add to the Application. Rubrics include simple valuations of actions (e.g. sending a message) and more complex valuations of collaboration. The set of rubrics available includes the following examples of rubrics attuned to collaboration.
1. Giving a Citation on a goal not created by the User
2. Answering a question posed in a Group or Project that the User is not a member of;
3. Sending a message to a user that is being led, managed or sponsored by the sender
4. Sending a message to a sponsor, manager, or leader
5. Back and forth communications wherein responses are made within a given time period
6. Comments created on objects not created by the user
7. Voting on the decisions created by others
8. Receiving votes on a decision point created by the user
9. Using a Meme not created by the user
10. Delegating then rescinding the delegation within a short period of time
11. Groups wherein the users generate a certain number of Information Events over a period of time

The last of the main norms of behavior setting mechanisms is the selection of a persona for a team, project, or group. Persona may also be set by a user in reference to themselves. A persona is a short hand means of declaring a team, project, or group personality separate from other evidence of how that set of users functions as a group. As an intention, a team, project, or group personal may be easily contrasted to the persona, if any, declared by the individual users. Where that comparison shows a disconnect, or where a persona conflicts with communications, decision making models, roles given, goals set, citations given or other indicators, the Application's expert system will make the observation and offer advice on the conflict.

### Work Guidelines and Feedback

The Application is not a project management system in a traditional sense; however, it does offer ways to set guidelines on work to be accomplished or other efforts of users and groups of users. The primary ways of offering work guidelines are through:
1. Role giving
2. Goal setting and giving citations
3. Milestone setting
4. Delegation

Teams, projects, groups and users can all be given roles. Roles are created by the leader of a team, or by the team's sponsor or manager. The roles given to a user flow down from the team level. If a user has two roles, “thinker” and “runner” given by the team leader, a project leader can give the user up to two roles within the project from the user's set of roles, namely “thinker” and “runner”. If the project leader chooses to give the user the “runner” role within the project and assigns the user to a group, the group leader can give the user zero or one roles from the user's set of project roles, i.e. “runner”. Where a group is formed directly within a team, as opposed to within a project, the group leader's role giving options for each member of the group are likewise the set of that user's team roles. Leader of teams can also set roles for the any projects or groups within the team. Likewise the leaders of projects can set roles for any groups within the project. Users with the manager or sponsor role can set roles for their teams as well as for their users.

Goals are given much like roles, with the main difference being that a goal can be created within the context of a project or group, as well as within a team. A goal can also be set for a user or group within the context of a project's milestone, as discussed below. In comparison with roles, goals have another key difference in that each user can give him or herself a goal. Such a goal does not make reference to the team, a project or a group. Rather it is a determination driven by the user for themselves.

Having a goal opens the door to receiving a citation. A citation is a recognition for effort towards a goal. The receiver may be a team, project, group or user. Any user can offer a citation to any other user; however, if the citation is not given by either a manager, sponsor, or leader, or by the goal giver it is marked as a nomination and does not carry a level. Levels are a simple numeric indication of degree, much like the stars of a movie or restaurant rating. However, the level of a citation can in fact be negative, thereby connoting poor effort, or even an effort that is counter productive. A user can not give a citation for work against goals given to themselves, but other users can all give citations on those goals without their being marked as a nomination.

Milestones exist within the context of a project. Project may have any number of milestones placed at any point in time before the target end date of the project. A milestone may be set, moved, or removed by the project leader, team leader, the project or team managers and the project or team sponsors. Milestones are primarily markers in time that may make reference to work effort by description and association with goals and the project itself. Groups can be assigned to work on a milestone, as can users.

Delegation is the act of a user explicitly requesting that another user act for them within a context. Any user can delegate to any other user within their team. Team managers and sponsors may also delegate their roles to a user on the team, to another manager or sponsor of the team, or to another team's manager or sponsor. In addition, a leader, manager, or sponsor may delegate a role from one user to another within the teams, projects, or groups they have responsibility for. A delegation carries a reason, a rescindation rule, a message, a set of capabilities delegated, and a context within which the delegation is active. Delegatable capabilities include virtually all actions within the Application. After a delegation some or all of the first user's responsibility within the delegation context is passed over to the user delegated to. This handover of control may include the abilities to:
1. Assign roles and goals
2. Give citations
3. Create projects and groups
4. Manage or lead teams, projects or groups
5. Manage the user's rubrics
6. Vote
7. Resolve decisions
   The main capability that is never delegated is messaging. The user who delegates or is delegated never loses control over their messages or Information Events. These stay theirs and continue to be private.

Rescindation rules define how the delegation may be undone. The rule is one of the following.
1. By the user who delegated
2. By the user who delegated or by the user delegated to
3. By the user who delegated, the user delegated to, or any leader, manager, or sponsor of either the delegator or the user delegated to
4. By only a leader, manager, or sponsor
5. By only a manager or sponsor
   Delegations can not be passed along. The user delegated to can not pass the delegated user's capabilities to another user by delegation. However, a leader, manager, or sponsor, or the delegated user themselves may undelegate, where that is permitted by the rescindation rule, and redelegate to a different user at any time.

### Observations and Advice Given by the Application

Using the information structures outlined above the Application can make observations and offer advice to users. The observations and advice are based on well-known principles of organizational dynamics and on the opportunities for positive team structures and function and positive user behavior within the Application, as understood by the Application's developers. The Application never forces any action or structure on the team, projects, groups or users based on its observations. Additionally, the users are not forced to open the management page for this functionality if they should not want to.

Observations are collected and analyzed by an expert system built around a core rules engine. The rules engine is a forward-chaining rules scheduling and execution environment using a RETE-like algorithm. Such rules engines are a well-understood commodity. The rules engine acts on a rules base composed of rules tailored to the Application's object model and method of use. Rules are scheduled for execution based on the contents of a working memory of facts. Each fact describes a circumstance within the Application that obtains due to user actions. When users take a significant action the objects acted on are updated in the working memory and a rules review is triggered that may result in the rules engine executing one or more rules. When a rule is executed it may result in an analysis object being placed in the scope of the user for use when that user enters the management page for observations and advice. An analysis object minimally contains information about the rule itself, a human readable observation, a priority, a date the observation was made and a set of suggested actions that the user can take to improve the circumstances that led to the observation. As noted, users are not forced to accept the suggestions and there is no effect on the user's score for action on the advice or for inaction, unless the action itself results in a change in score based on the user's rubrics. The analysis history of a user is available to that user and his or her managers.

In the preferred embodiment, rules are loaded when the first user takes an action that the Application considers significant. Loading of rules is not in itself expensive in terms of processing time; however, the rules search when the working memory changes may be expensive, and will be in the usual case due to the number of rules. For that reason the preferred embodiment requires substantial amounts of RAM and one or more fast processors. The impact of the frequent rules searches can be minimized by customizing the rules set for a particular business. Customization can be achieved either by disabling certain rules within the observations and analysis management page by the administrator of the Application, or by customizing the text rules files and restarting the Application, or by configuring the Application to disregard certain events rather than using them to update working memory and thereby trigger a rules search.

I claim:

1. A software apparatus composed of a software model, a view on the model, data analysis rules separate from the logic inherent in the model and view, and integration components (collectively hereinafter the “Application”), and method of its routine use by work teams of two or more individuals for the purpose of improving the interpersonal coherence and thereby the work performance of the said team by, inter alia, the following unordered steps
Improving the predictability of work communications by setting norms for team communication and by tracing actual communication patterns and content indicators for analysis and review;
Conforming perceptions amongst team members of team and individual roles, goals, work results, relationships, behaviors and the values placed on behaviors by individuals and the team by explicitly documenting those aspects of the team within the Application;
Defining and using an explicit decision making model (such as “by consensus”, “by majority”, etc.);
Guiding the decision making process through questions and answers, propositions, resolutions, and voting;
Organizing users into subgroups with specific goals, values, relationships and evaluation results;
Encouraging a sense of community within the work team by enabling and making explicit shared responsibilities, increasing the role of member to leader and leader to member feedback, and providing ways to realize a group personality via personalization of the Application, both by user actions and by interpretation of user preferences by the Application, by averaging or by another algorithm, in a way that is best described as “group personalization” of the Application;

2. The Application of claim 1 wherein is provided a work team model comprised of the following parts (hereinafter “objects” or “entities” interchangeably) and relationships between the same for the purpose of defining a data structure to collect and manage the data required by the Application for the analysis of team relationships and performance with the objective of troubleshooting team performance problems rooted in interpersonal relations, including negotiations, communications, perspective sharing, group organization and leadership, expectation setting, and other concepts common to the analysis of work relationships,
Users, holding data and references regarding identification, preferences, current state, Groups, Relationships, Projects, Teams, Messages, Information Events, Rubrics, etc., as those terms are defined below;
Groups, as collections of users, holding data and references regarding the Group itself (e.g. name, description, purpose, etc.), its User members, a default Decision Model, Roles, Goals, etc., as those terms are defined below;
Projects, holding data and references regarding the Project itself, Milestones, Users, Groups, a Team, a default Decision Model, Roles, Goals, etc., as those terms are defined below;
Teams, holding data and references regarding Users, Groups, Projects, a default Decision Model, Roles, Goals, as those terms are defined below;
Portfolios, holding data and references regarding Users, Groups, one or more Projects, and one or more Teams;
Milestones, signifying a period of time elapsed or an amount of work accomplished within the context of a Project, a User, a Group, or a Team;
Persona, signifying a general and recognizable way of acting as a user, group, project, or team adopted by a User or Users to express a desire for the user, group, project, or team to be seen to behave as the Persona suggests he, she, or it will behave;
Skills, signifying an ability of a User or of a Group;
Goals, signifying work expected of a user;
Citations, signifying a result of work against a Goal by a User;
Petitions, signifying a request for recognition by a User to another User;
Comments, signifying a personal opinion or explanation by a User associated with an object;
Decision Models, signifying a decision making modus operandi of a group of users as defined by a Group, a Project, or a Team;
Decisions, signifying a choice made or to be made by one or more users for a Group;
Questions, signifying a request for information by a user, the answer to which has an implied force less than that of the Decision;
Votes, signifying an approval or disapproval by a User of another object, but principally the Question and Decision objects, wherein a vote is considered binding for the purposes of the Application's analysis and possible actions;
Topics, signifying an area of discussion of a Group and which in principle may be attached to any other object within the Application;
Memes, signifying a label or short comment that may be associated with one or more objects within the Application and that may be shared between Users for their own use;
Relationships between Users, signifying a real-world work relationship between users of the Application;
Delegations from User to User, signifying the intention of a user to permit another user to act for him or her within the Application, and by extension within the physical work team external to the application;
Roles, signifying a job, duty, or distinction specific to the User holding the role in the context of a Group, Project, or Teams;
Messages, signifying a message sent within the Application, in the form of an email-like message, or in the form of an instant messaging-like message, or within a system which is integrated with the Application;
Information Events, signifying data points collected within the Application that are sourced within the Application's objects or from another system integrated with the Application such that the application may read state therein contained that pertains to the users, groups, projects, or work teams modeled in the Application;
Message Dictionaries, signifying the tokens found in the communications represented by Information Events that are indicative of the matter the communications pertain to, and that may stand in for the User's relationship to the matter of the communication in a way that is concise and that makes circumspect use of company owned, but conceptually private, communications on the matter for display within the Application in a variety of ways as required for display in the context of skills, responsibilities, scoring, and mildly competitive evaluation of individual performance;
Rules, signifying the rules within the Application that exist to codify the best practices of an organization and its work teams;
Analysis, signifying the result of the Application's finding a Rule that obtains, and including the observation made by the Application, a statement of the Rule, and a suggested course of action to be taken by the User receiving the Analysis;
Rubrics for evaluating the actions and state of a User, Users, Groups, Projects, and Teams based on the object model hereinbefore described;
Scores, signifying the application of a Rubric to the observed behavior of a User;

3. The Application model of claim 2 incorporated within a set of management and interaction user interface screens (hereinafter “management pages”) where each management page, which may include a number of actual Web pages or Web page fragments in its logical scope, offers facilities for, inter alia, object creation, updating, deletion, and inspection, and that provide a means for company management to configure the Application such that options, ranges and rules governing actions are pre-set to allow only those options, values and actions that support company or work team policies, and such that the members of a work team may use the set of management pages to construct a representation of themselves, their team, its associated groups, projects, and other related objects, and the norms of behavior associated with that team, as represented by certain of the hereinbefore described model objects, which set of management pages in the context of any given user is comprised of
A management page for the user's credentials, descriptive data, persona, current state indicators, and other quasi-personal information pertaining to a User;
A management page for the teams the logged in user participates in or manages;
A management page for the relationships with friends and coworkers of the logged in user, and for his or her other work life relationships;
A management page for the projects the logged in user participates in;
A management page for the message communications, topics and memes the logged in user has in some way taken part in;
A management page for the roles the logged in user has in his or her groups, projects, and teams;
A management page for the goals of the logged in user and his or her citations;
A management page for the work skills, interests, message keywords, and other knowledge indicating profile information of the logged in user;
A management page for the values and norms of the logged in user denoted by their Rubrics and evaluated by their Scores;
A management page for the decision models, decisions, questions and votes pertaining to the logged in user;
A management page for the analysis and advice that the application offers the logged in user;

4. The Application's model, and management pages (hereinafter the “Web application”) of claim 3, extended to include facilities for the analysis and display of interpersonal communications in forms including as a time series, as a list, as sets grouped according to responses to an original message or by type or by user or another set grouping indicators, as a network diagram wherein users are the vertices of a directed graph taking messages and other Information Events to be the edges connecting the vertices and message and Information Event counts providing edge weights, by cluster according to term frequency, and by other indicators of sequence, relatedness, weighting of indicated relationships, timing, reciprocity, and like measures that provide raw materials for the Application to use in generating visualizations that enable users of the Web Application to gain specific insights as to the appropriateness of the communications and participation-indicated relationships between team members and thereby draw conclusions as to how team productivity may be raised;

5. The Web Application of claim 4. wherein the facilities for the analysis and display of interpersonal communications also provide analysis and display of static indictors of actions and indirect communications between users as mediated by the Web Application through the use of the several group norms indicator objects and indirect communications media objects for the purpose of more completely elucidating the scope and patterns of communication between users of the Web Application so that said users may gain specific insights as to the appropriateness of the communications and participation-indicated relationships between team members and thereby draw conclusions as to how team productivity may be raised, which set of norms indicator objects and media objects is comprised of
Roles;
Persona;
Goals;
Citations;
Groups;
Relationships;
Decision Models;
Decisions;
Questions;
Votes;
Memes;
Topics;
Rubrics;
Scores;
Skills;
Milestones;
Comments;
Petitions;
Delegations;

6. The Web Application of claim 5, wherein is embedded a forward chaining expert system (a well-known component type defined here as, briefly, a rule set specific to the Application plus an off the shelf rules selection and execution engine plus a working memory for fact data, and including the application programming interface of the execution engine; hereinafter the “Expert System”), into the working memory of which is placed references to teams and the objects related to them by reference (to with, Users, Groups, Projects, etc.) so that as the Application model data is loaded and changes a RETE-like algorithm within the rules selection engine core of the Expert System efficiently selects rules for consideration that, if any obtain, may modify the Application model data, or provide an Analysis to the User object that is active (i.e. the user has logged into the Web Application) and for which the rule pertains, or both, and wherein the Analysis, if any, will contain the rule identity, an indicator of the condition observed by the expert system that triggered the rule, date, priority, and one or more suggestions for behavior that would facilitate team or group productivity, at which point said Analysis object is presented to the user for their consideration and possible action to correct, mitigate or complement the situation recognized by the rule, all of which with the goal of identifying present or potential interpersonal issues brought about by the course of team work actions and enabling the user to consider and correct the same as needed;

7. The Expert System of claim 6, wherein the set of rules and their contributing data is made configurable to the management requirements of a specific business, and including the Web Application's desired technical performance characteristics, by means of any or all of a management page that manipulates a configuration that is stored as configuration objects, by a management page that inhibits the adding of information into the working memory of the Expert System, or by the editing of, or adding to, or removing from a set of rules written in the interpreted rule specification language of the rules selection core of the Expert System and configured by a technical administrator, which minimum set, before any customization, is comprised of the following rules
A rule testing the typical pattern of voting within a team and its appropriateness to the Decision Model of the team;
A likewise rule testing in the context of a project;
A likewise rule testing in the context of a group;
A rule testing the presence of a role for each user within a team, wherein one or more roles is expected;
A likewise rule testing in the context of a project;
A likewise rule testing in the context of any group that is a descendent of a Project or a Team;
A rule testing the presence of a goal for each user within a team, wherein one or more goals is expected;
A likewise rule testing in the context of a project;
A likewise rule testing in the context of any group that is a descendent of a Project or a Team;
A rule testing the communication between the leader User within any Team and the other members of that Team, wherein the expectation is that a configurable number of communications per user per day is obtained;
A likewise rule testing in the context of a project;
A likewise rule testing in the context of any group that is a descendent of a Project or a Team;
A rule testing the communication between any given member of a team and the other members of that team, wherein the expectation is that a configurable number of communications per user per day is obtained;
A likewise rule testing in the context of a project;
A likewise rule testing in the context of any group that is a descendent of a Project or a Team;
A rule testing that each Team has at least one leader User;
A likewise rule testing in the context of a Project;
A likewise rule testing in the context of any group that is a descendent of a Project or a Team;
A rule testing that each Team has at least one sponsor User that is not a member of the Team;
A likewise rule testing in the context of a Project;
A likewise rule testing in the context of any group that is a descendent of a Project or a Team;
A rule testing that each Team has one and only one default Decision Model;
A likewise rule testing in the context of a Project;
A likewise rule testing in the context of any group that is a descendent of a Project or a Team;
A rule testing that a given User has a configurable minimum number of Relationships;
A rule testing that a given User has a configurable minimum number of Questions;
A rule testing that a given User has a configurable minimum number of Votes;
A rule testing that a given User has a configurable minimum number of Messages;
A rule testing that a given User has a configurable minimum number of Skills;
A rule testing that a given User has a configurable minimum number of Rubrics with non-default values;
A rule testing that a given User has a configurable minimum number of Comments;
A rule testing that a given User has a configurable minimum number of Groups it is a member of;
A rule testing that a given User has exactly one Persona;
A rule testing that a given leader User has a configurable minimum number of Citations;
A rule testing that the Users a given leader User leads within their leadership context entity have set a minimum number of non-default valued Rubrics;
A rule testing that a given leader User has created and populated a configurable minimum number of Groups;
A rule testing that a given leader User has a configurable minimum number of Comments on other User's objects;
A rule testing that a given leader User has a configurable minimum number of Comments;
A rule testing that a given leader User has not assigned more than a configurable minimum number of Roles to any given User;
A rule testing that a given leader User has not assigned more than a configurable minimum number of Goals to any given User;
A likewise rule testing in the context of a Project;
A likewise rule testing in the context of a Group;
A likewise rule testing in the context of a Team;
A rule testing that a given Team has a given set of Roles assigned to its members;
A likewise rule testing in the context of a Project;
A likewise rule testing in the context of a Group;
A rule testing that no group has less than a configurable number of Users;
A rule testing that no project has more than a configurable number of Users that are not assigned to a Group;
A rule testing that no User give more than a configurable number of Citations;
A rule testing that the average value of Citations given by a User not be negative, where a negative valued Citation denotes a disapproval of performance;
A rule testing that the average value of Citations given by the Users in a given group not be negative;
A likewise rule testing in the context of a Project;
A likewise rule testing in the context of a Team;
A rule testing that the sponsor Users of a given Team, where the number of sponsor Users is greater than one, communicate not less than a configurable number of times per day;
A rule testing that the sponsor Users of a given Project, where the number of sponsor Users is greater than one, communicate not less than a configurable number of times per day;
A rule testing that the sponsor Users of a given Group, where the number of sponsor Users is greater than one, communicate not less than a configurable number of times per day;
A rule testing that all Decision are resolved within a given number of hours;
A rule testing that all Questions are answered within a given number of hours;
A rule testing that a configurable number of messages for any given User are responded to within a given number of hours;
A rule testing that any given User generate a configurable number of Information Events per day;
A rule testing that any given User's profile is complete to a configurable degree;
A likewise rule testing Groups;
A likewise rule testing Projects;
A likewise rule testing Teams;
A rule testing that any given User maintain a given number of Rubrics;
A rule testing that no User's Rubric values be more than a configurable distance from the mean value for that Rubric within the team;
A rule testing that the result of calculating the Score of a given User using their own Rubric not fall below a configurable amount;
A likewise rule testing in the context of a Team's average Rubric;
A likewise rule testing in the context of a Project's average Rubric;
A likewise rule testing in the context of a Group's average Rubric;
A likewise rule testing in the context of a Team's leader's Rubric;
A likewise rule testing in the context of a Project's leader's Rubric;
A likewise rule testing in the context of a Group's leader's Rubric;

8. The Web Application of claim 5 wherein a management page for Rubrics and Scores provides a means for each user to configure a set of values on a configurable set of behaviors, said values being used to generate a Score for the User and for the User's selection of any other User, Group, Project, or Team, based on the combination of the Rubric value and the number of times the user or collection of users exhibits the behavior within the context of a Team, Project, Group, or the User's own context, and wherein Rubric values for the grouped Users of a Group, Project or Team are averaged, configurably using a weighting function that gives greater account to the Rubric values of leader and/or sponsor Users, or by another agglomerating algorithm, are used to provide a standard Rubric value for that Group, Project or Team that can be used to generate a second Score for the User, Group, Project or Team for comparison with the Score generated with the given User's own set of Rubric values, as well as with the Score for the User that would be generated by using the leading User(s) Rubric values for the given Group, Project, or Team context, which set of Rubrics with attendant Scores to include minimally, not comprehensively, the following measures based on actions
A Rubric for setting rubric values to a value other than the default;
A Rubric for votes made;
A Rubric for messages sent;
A Rubric for comments made;
A Rubric for citations given;
A Rubric for citations received
A Rubric for goals given;
A Rubric for goals received;
A Rubric for Roles received;
A Rubric for Roles given;
A Rubric for setting a decision model;
A Rubric for Decisions created;
A Rubric for Decisions resolved;
A Rubric for Questions created;
A Rubric for Questions answered;
A Rubric for Memes created;
A Rubric for Memes applied;
A Rubric for Topics created;
A Rubric for Relationships created;
A Rubric for skills advertised;
A Rubric for a Persona being set;
A Rubric for petitions made;
A Rubric for delegations made;
A Rubric for milestones set;
A Rubric for Groups created;
and the following measures based on participation
A Rubric for giving a Citation on a goal not created by the User;
A Rubric for answering a question posed in a Group or Project that the User is not a member of;
A Rubric for sending a message to a leader User of the User;
A Rubric for sending a message to a User that is being led by the given User;
A Rubric for sending a message to a User that is being sponsored by the given User within a Team, Project or Group;
A Rubric for sending a message to a sponsor User of the Team;
A Rubric for sending a message to a sponsor User of a Project;
A Rubric for sending a message to a sponsor User of a Group;
A Rubric for back and forth communications between a set of Users wherein messages are sent within a given time period;
A Rubric for Comments created on objects not created by the given User;
A Rubric for Information Events created by the given User;
A Rubric for associating Information Events automatically created by the Application to match events in external system with other objects within the Application (e.g. with Milestones or Groups);
A Rubric for voting on the Decision objects created by others;
A Rubric for receiving votes on a Decision object created by the given User;
A Rubric for using a Meme not created by the given User;
A Rubric for delegating to a User then rescinding the delegation;
A Rubric for Groups wherein the Users generate a configurable amount of Information Events;
A Rubric for closing a Group or Project when all of its Milestones are marked complete;

9. The Web Application of claim 8, wherein a set of management pages are provided such that a user identified as a manager by a manager Role may configure one or more Policy objects that will be associated with a team or teams, but not visible or accessible to said team or teams, which Policy object will delimit the Application as to the options and, optionally, their ranges available to non-manager users by subtraction and constriction and will redefine user viewable terms where such terms conflict with terms in current use in the business so that a single manager may set policy and control terms for all other users of the Application and thereby customize the Application at a high level for the specificities of the business and requirements of management with the goal of decreasing resistance to the use of the Application by users while increasing the value of the Application to management;

10. The Web Application of claim 9, wherein is provided an additional set of management pages which give one or more manager users a wide view on team and project performance across the business, and that provide the ability to perform the following not comprehensive set of tasks for the purpose of creating, setting in motion, and reviewing the performance and interpersonal coherence indicating metrics of a unified set of work teams, as represented within the Application
Create Teams and Projects, and thereby become their sponsor;
Assign and reassign Projects to Teams;
Assign Users to Teams and Projects;
Transfer Users from Team to Team or from Project to Project;
Remove Users from a Project or Team;
Set a Policy for a Team, overriding the default Policy;
Compare Team by Team or by group of Teams in a report format;
Compare Project by Project or by group of Projects in a report format;
Compare Group by Group or Group by group of Groups in a report format;
Compare User by User or User by group of Users in a report format;
Give Users the manager Role;
Take the manager Role away from Users wherein the User that will lose the role received it from the User that is taking the role away;
Set levels of access for Users that the said manager has given the manager role to such that the Users may assign, reassign, remove, compare and the other aforementioned tasks within a limited scope set by the User giving the manager Role;
Set a Policy to be the default Policy for all Teams;

11. The Application of claim 3, wherein a set of pre-built integration modules (hereinafter “Modules”) is available to an administrator of the Application for the purpose of reading data from external communications and planning systems and storing a metadata abstract of each record pertaining to a user of the Application as an Information Event, as hereinbefore defined, that may be analyzed as first-class part of the total data held by the Application pertaining to the said user, and wherein the Modules adhere to a well-known interface such that two external systems can be identically managed as far as possible with the goal of making the configuration and administration of said Modules as simple as possible in the context of a wide diversity of such external systems as the Application will be required to be integrated with when the sum of all businesses that may use the Application is considered, and wherein the said administrator may configure the Application to use a given subset of the Modules based on the information systems available within the businesses network or reachable therefrom, and wherein the Modules may have severally set a data read schedule or alternatively be set to read data for a given user at the start of their session on the Web Application and at points thereafter prior to the end of the session spaced a configurable time apart, and wherein the Modules severally address one or more of the following areas of integration functionality which comprise the integration scope of the Application
The integration of Project Management stand-alone application tools and servers, wherein an example of the former is Microsoft Project and an example of the latter is Deltek Vision;
The integration of email servers, wherein an example is Microsoft Exchange;
The integration of instant messaging servers, wherein an example is the Google Talk service;
The integration of directory services servers, wherein an example is Microsoft Active Directory;
The integration of document management servers, wherein an example is EMC Documentum Content Server;
The integration of configuration management servers, wherein an example is the Subversion server;
The integration of HTTP and WebDAV servers and proxy server for the same protocols, wherein an example of the former is the Apache server and an example of the latter is the Netscape Proxy Server;
The integration of expertise management servers, wherein an example is Tacit Software ActiveNet;
The integration of human resources management servers, wherein an example is the SuccessFactors service;
The integration of issue management servers, wherein an example is Atlassian JIRA;
The integration of collaboration servers, wherein an example is IBM Lotus Notes;
